(19) United States
(12) Patent Application Publication
(10) Pub. No.: US 2026/0186777 A1
(43) Pub. Date: Jul. 2, 2026

(54) PROCESSING 16-BIT BRAIN FLOATING-POINT INSTRUCTIONS

(71) Applicant: ADVANCED MICRO DEVICES, INC., Santa Clara, CA (US)

(72) Inventors: Bin He, Orlando, FL (US); Subramaniam Maiyuran, Folsom, CA (US)

(21) Appl. No.: 19/003,715

(22) Filed: Dec. 27, 2024

(51) Int. Cl. G06F 9/30

(52) U.S. Cl. CPC G06F 9/30025; G06F 9/3001; G06F 9/30036

(57) ABSTRACT

A processing system and method for executing arithmetic and conversion operations involving 16-bit brain floating-point (BF16)-formatted data are described. An instruction specifying either an arithmetic or conversion operation and a first data element in BF16 data format are received. For arithmetic operations, the exponents of the data elements are aligned, and a result is generated using the aligned exponents. For conversion operations, the mantissa of the BF16 data element is scaled based on its exponent, and the element is converted to a second data format, such as FP32 or a reduced-precision format, using precision-aware scaling and rounding. The result is stored in operations registers, such as for additional processing.

### BACKGROUND

Machine learning (ML) and artificial intelligence (AI) workloads have grown increasingly complex, driven by advances in natural language processing, computer vision, and other domains that require the efficient processing of large-scale datasets. These workloads often involve matrix multiplications, tensor operations, and other computationally intensive tasks.

To meet the computational demands of modern AI systems, data formats such as floating-point 32-bit (FP32) and floating-point 16-bit (FP16) have been widely adopted for numerical representation. However, these formats present trade-offs between precision, memory bandwidth usage, and computational efficiency. For example, FP32 provides high precision but can be resource-intensive, while FP16 offers a reduction in computational and memory requirements but may lack sufficient precision for certain AI tasks.

The 16-bit brain floating-point data format (typically termed bfloat16 or BF16) provides a balance between computational efficiency and precision suitable for tasks common in ML and AI applications, such as matrix multiplications and tensor processing. However, and despite the advantages associated with the BF16 data format, current architectures often rely on multi-step processes or emulation techniques to support BF16 arithmetic, resulting in performance bottlenecks and increased latency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates the 16-bit brain floating-point (BF16) data format, as used in various embodiments described herein.

FIG. 2 is a block diagram of a processing system providing arithmetic and conversion operations involving BF16-formatted data, in accordance with some embodiments.

FIG. 3 illustrates an operational routine for processing instructions involving BF16-formatted data elements via a specialized instruction set, in accordance with some embodiments.

### DETAILED DESCRIPTION

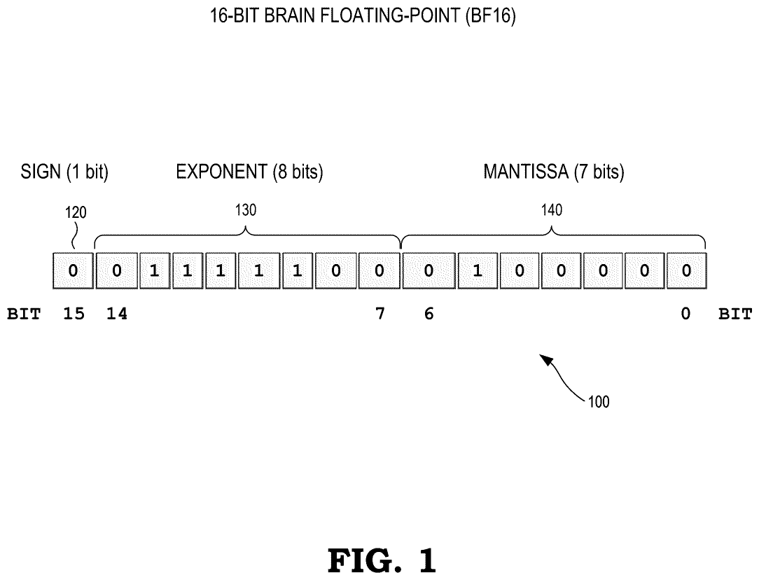

FIG. 1 illustrates the 16-bit brain floating-point (BF16) data format, as used in various embodiments described herein. The BF16 data format includes a total of 16 bits, which are divided into three fields: a sign bit 120 (1 bit), an exponent 130 (8 bits), and a mantissa 140 (7 bits). These fields collectively define the numerical value represented by the BF16 data element 100.

The sign bit 120 occupies the most significant bit (bit 15) and indicates the sign of the number, such that 0 represents a positive value and 1 represents a negative value.

The exponent 130 is an 8-bit field spanning bits 14 through 7. The exponent determines a scaling factor applied to the mantissa and provides the BF16 with the same dynamic range as the 32-bit floating-point (FP32) data format.

The mantissa 140 is a 7-bit field spanning bits 6 through 0. Compared to FP32, the BF16 data format sacrifices mantissa precision to minimize storage and computational overhead while retaining the dynamic range needed for applications such as (as non-limiting examples) machine learning and artificial intelligence. In particular, the BF16 representation retains the range of FP32 (which also uses an 8-bit exponent) but reduces the precision of the mantissa from 23 bits in FP32 to 7 bits in BF16. By comparison, FP16 uses 5 bits for the exponent and 10 bits for the mantissa, offering less range than BF16 but greater precision.

These differences make BF16 particularly suitable for applications where the dynamic range of FP32 is advantageous but the full precision of its mantissa is not required. In the context of AI workloads, where many operations involve accumulating and averaging large quantities of data, the reduced precision of BF16 is often sufficient to achieve acceptable results while offering improvements in computational efficiency and memory bandwidth usage. BF16 can thus be leveraged to process larger datasets more quickly, which is valuable, e.g., for training and inference in deep learning models.

As noted above, despite the advantages associated with the BF16 data format, previous architectural approaches to BF16 operations typically rely on multi-step processes or emulation techniques to support BF16 arithmetic, rather than directly supporting the format. Existing solutions typically involve converting data between formats, which introduces additional computational overhead and complicates the efficient execution of AI workloads. As the size and complexity of AI models continue to grow, these inefficiencies can lead to significant constraints on throughput, scalability, and real-time processing capabilities.

Embodiments of techniques described herein provide systems and methods for efficiently handling BF16 data directly (such as in vector arithmetic logic units (VALU) of a processing unit) via a specialized instruction set. In certain embodiments, native support is enabled for arithmetic operations using the BF16 data format, such as fused multiply-add (FMA), addition, and multiplication. By incorporating mixed-precision operations, embodiments enable interaction between BF16 and other formats (e.g., FP32) without needing to perform intermediate conversion steps.

In certain embodiments, a processing unit implementing the techniques described herein provides and executes an instruction set having multiple instructions for converting data between precision formats, simplifying the processing of datasets in mixed-format environments. By directly supporting BF16 operations within the processing unit and/or instruction set, such embodiments may reduce compute cycles, minimize memory bandwidth usage, and enhance the overall throughput of AI and machine learning workloads. In some embodiments, the instruction set may be tailored for applications involving matrix multiplications, tensor operations, and other computational tasks commonly encountered in AI systems.

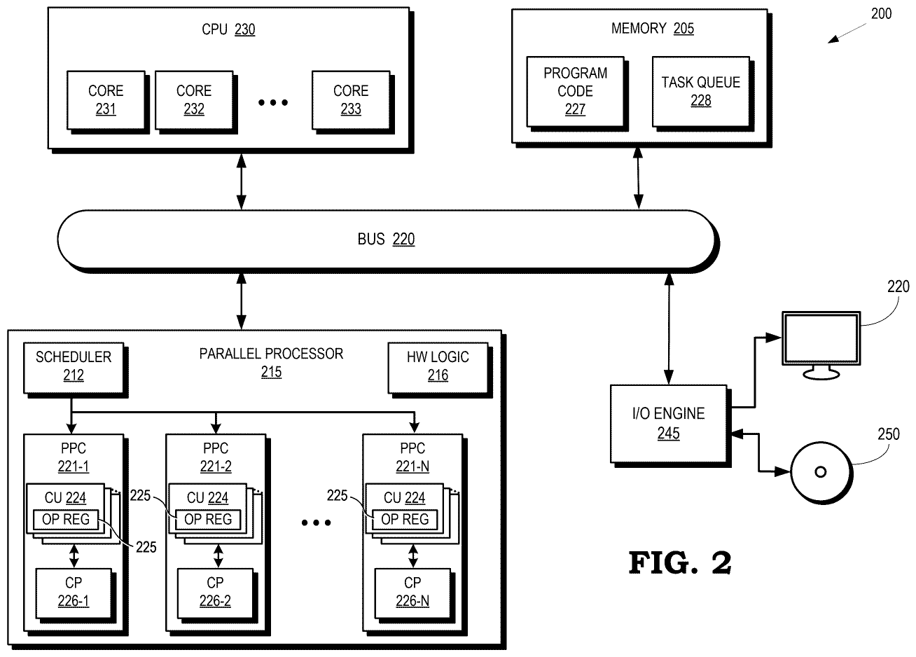

FIG. 2 is a block diagram of a processing system 200 providing BF16 arithmetic and conversion operations according to some embodiments. The processing system 200 includes or has access to a memory 205 or other storage component that is implemented using a non-transitory computer readable medium such as a dynamic random-access memory (DRAM). However, in some cases, the memory 205 is implemented using other types of memory including static random-access memory (SRAM), nonvolatile RAM, and the like. The memory 205 is referred to as an external memory as it is implemented external to the processing units implemented in the processing system 200. The processing system 200 also includes a bus 210 to support communication between entities implemented in the processing system 200, such as the memory 205. Some embodiments of the processing system 200 include other buses, bridges, switches, routers, and the like, which are not shown in FIG. 2 in the interest of clarity.

The techniques described herein are, in different embodiments, employed at any of a variety of parallel processors (e.g., vector processors, graphics processing units (GPUs), general-purpose GPUs (GPGPUs), non-scalar processors, highly parallel processors, artificial intelligence (AI) processors, inference engines, machine learning processors, and other multithreaded processing units).

In the depicted embodiment, a parallel processor 215 renders images for presentation by the processing system 200 on a display 220. For example, the parallel processor 215 renders objects to produce values of pixels that are provided to the display 220, which uses the pixel values to display an image representing the rendered objects. However, the parallel processor 215 is also capable of executing software not directly involved in any graphics processing pipeline, such as machine learning applications and other advanced computing applications.

In order to provide the parallel processor 215 with the flexibility to execute tasks related to a graphics processing pipeline, machine learning, or other advanced computing applications in an efficient manner, the parallel processor 215 includes a plurality of parallel processing cores (PPCs), such as PPCs 221-1, 221-2, and 221-N (collectively referred to herein as PPCs 221), which are configured to process tasks and offer one or more of GPU functionality and optimized processing for advanced applications that utilize, e.g., reduced precision data common in machine learning. By providing the parallel processor 215 with a plurality of PPCs 221, the parallel processor 215 is able to perform a number of tasks simultaneously while latency and data transfer energy between the PPCs 221 is minimized. The PPCs 221 are typically implemented using shared hardware resources of the parallel processor 215, such as compute units 224. In some embodiments, the PPCs 221 are used to implement shaders, such as geometry shaders, pixel shaders, and the like. Generally, the PPCs 221 are a logical grouping of processing hardware, which in some embodiments includes, e.g., one or more processing chiplets, cores, and/or caches. The PPCs 221 typically include or access a number of compute units 224 in the parallel processor 215, and each of the compute units 224 typically includes a number of single-instruction-multiple-data (SIMD) units. The number of PPCs 221 implemented in the parallel processor 215 is a matter of design choice and some embodiments of the parallel processor 215 include more or fewer PPCs than are shown in FIG. 2.

In the depicted embodiment, each compute unit 224 includes one or more operations registers 225, which are configured to store data elements and intermediate results during execution of operations, such as arithmetic and conversion operations involving BF16-formatted data. In this and other embodiments, each operations register 225 may be, as non-limiting examples, a general-purpose register of the processing unit, a vector general-purpose register (VGPR) of the processing unit, or a tensor core of the processing unit. These registers enable efficient handling of BF16 data, facilitating arithmetic operations and conversions directly within the compute units 224 without requiring frequent access to external memory.

In the depicted embodiment, the processing system 200 also includes a CPU 230 that is connected to the bus 210 through which it communicates with the parallel processor 215 and the memory 205. The CPU 230 implements a plurality of processor cores 231, 232, 233 (collectively referred to herein as “processor cores 231-133”) that execute instructions concurrently or in parallel. The number of processor cores 231-133 implemented in the CPU 230 is a matter of design choice and some embodiments include more or fewer processor cores than are illustrated in FIG. 2. The processor cores 231-133 execute instructions such as program code 227 stored in the memory 205 and the CPU 230 stores information in the memory 205 such as the results of the executed instructions. The CPU 230 is also able to initiate graphics or other processing by issuing draw calls or other tasks to the parallel processor 215.

In the depicted embodiment, the PPCs 221 each include a command processor (CP) 226, such as CPs 226-1, 226-2, and 226-N, to manage and facilitate execution of incoming instructions or tasks. Each CP 226 is configured to receive and parse incoming instructions, interpreting their operation codes and associated metadata to determine the type of operation to be performed. For example, in certain embodiments the CP 226 identifies whether an incoming instruction specifies an arithmetic operation, such as a fused multiply-add, addition, or multiplication, or a conversion operation for transitioning data between BF16 and another format, such as FP32. Based on this determination, the CP 226 directs the instruction to the appropriate execution units within the processing system. For example, the CP 226 may ensure that arithmetic operations are executed by arithmetic logic units (ALUs) or similar components, while conversion operations are handled by format transformation units optimized for scaling, rounding, and format adaptation.

In the depicted embodiment, tasks are stored in a task queue 228 in the memory 205, which also stores dependency information related to the tasks. In some embodiments, the task queue 228 is duplicated or instead stored in the parallel processor 215 and/or CPU 230. Generally, the task queue 228 is stored in a location accessible by the CPU 230 and the parallel processor 215 so that the status of the tasks and dependency information in the task queue 228 can be monitored and new tasks and dependency information can be added as needed by, e.g., the CPU 230 or the parallel processor 215. In some embodiments, the task queue 228 is implemented as a circular buffer with associated read and write pointers, but in other embodiments the task queue 228 takes other forms such as an ordered list or cache.

As shown in FIG. 2, the parallel processor 215 further includes a scheduler 212, which is implemented as any cooperating collection of hardware, software, or a combination thereof that performs functions and computations associated with assigning threads, workgroups, waves, or other tasks, such as compute shader threads, to one or more of the PPCs 221. In some embodiments, one or more of the PPCs 221 are able to be selectively addressed or controlled independently from one another or addressed or controlled in groups of two or more such that the parallel processor 215, the scheduler 212, and/or a user is able to control which PPCs 221 perform specific tasks or to distribute tasks across a number of PPCs 221.

In some embodiments, the parallel processor 215 is used for general-purpose computing. For example, the operations registers 225 may be employed for processing tasks involving BF16 data formats, enabling efficient execution of arithmetic operations such as fused multiply-add, addition, and multiplication, as well as data conversions between BF16 and other formats (e.g., FP32). These registers allow for streamlined storage and manipulation of BF16 data directly within the compute units 224, minimizing external memory access and ensuring alignment with the execution resources of the compute units 224. The parallel processor 215 executes instructions such as program code 227 stored in the memory 205 based on dependency information stored in the task queue 228, and the parallel processor 215 stores information in the memory 205 such as the results of the executed instructions, new dependency information for tasks, and indications that dependencies have been satisfied, e.g., when tasks associated with dependency information have finished executing.

In some embodiments, the scheduler 212 and the CPs 226 work together or in parallel to process tasks and dependency information from the task queue 228. For example, in some embodiments, the scheduler 212 assigns tasks to the compute units 224, and the compute units 224 interface with the task queue 228 to determine when tasks can be executed out of order based on dependency information specified in the task queue 228. In some embodiments, the scheduler 212 interfaces with the task queue 228 to determine which tasks to assign to the compute units 224 based on the dependency information. Accordingly, in some embodiments, the scheduler 212 and compute units 224 work together to ensure maximum parallelization and optimized throughput of task execution in the parallel processor 215.

In the example of FIG. 2, an input/output (I/O) engine 245 handles input or output operations associated with the display 220, as well as other elements of the processing system 200 such as keyboards, mice, printers, external disks, and the like. The I/O engine 245 is coupled to the bus 210 so that the I/O engine 245 communicates with the memory 205, the parallel processor 215, or the CPU 230. The I/O engine 245 reads information stored on an external storage component 250, which is implemented using a non-transitory computer readable medium such as a hard disk, compact disc (CD), a digital video disc (DVD), and the like. The I/O engine 245 is also able to write information to the external storage component 250, such as the results of processing by the parallel processor 215 or the CPU 230.

For arithmetic operations involving floating-point formats such as BF16 and FP32, operands with different scales can be accurately processed via exponent alignment. This alignment is achieved through bit-shifting of the mantissa of one or both operands. The process ensures that the exponents are brought into alignment, allowing the arithmetic operation to proceed without loss of accuracy due to mismatched scales.

To align exponents, the mantissa of the operand with the smaller exponent is shifted to the right by a number of bits equal to the difference between the two exponents. This adjustment scales the smaller value to match the scale of the larger value, effectively bringing the two operands into alignment. For example, if one operand has an exponent of 5 and the other has an exponent of 3, the mantissa of the operand with the exponent of 3 is shifted right by two bits. Once aligned, the arithmetic operation, such as addition or subtraction, is performed on the adjusted mantissas.

Following the arithmetic operation, normalization may be used to adjust the resulting value. This involves modifying the exponent and mantissa of the result to ensure that the mantissa fits within the available bit-width, such as the 7 bits allocated for the mantissa in the BF16 data format. Thus, for example, the parallel processor 215 may normalize a generated result (the resulting value) in accordance with the BF16 data format. In certain embodiments, rounding techniques, such as round-to-nearest-even, may be applied during normalization to maintain numerical accuracy and minimize rounding errors.

For multiplication operations, exponent alignment is not required because the exponents of the operands are added directly as part of the operation. However, normalization of the result may still be necessary to ensure that the resulting value adheres to the constraints of the BF16 data format.

In embodiments described herein, exponent alignment is handled by hardware logic 216 to compare exponents, shift mantissas as needed, and perform the arithmetic operation on the aligned values. While this process is implicit to the user, it ensures efficient and accurate execution of operations such as fused multiply-add, addition, and subtraction. The reduced precision of the BF16 mantissa, relative to FP32, is accounted for during alignment and normalization, with rounding applied to mitigate precision loss.

Table 1 below provides a pseudocode overview of an example instruction set designed for efficient arithmetic operations and data handling using the BF16 data format, in accordance with some embodiments. Each instruction substantially optimizes processing tasks commonly encountered in machine learning and artificial intelligence workloads, such as matrix multiplications and tensor operations. Table 1 includes the name of each instruction, a description of its function, and comments highlighting specific implementation details or constraints. These instructions enable an executing processing unit to perform these operations (such as fused multiply-add, addition, multiplication, and comparisons) directly on BF16 data, as well as conversions between BF16 and other formats like FP32. By leveraging this instruction set, the processing system minimizes computational overhead, reduces memory bandwidth usage, and improves the throughput of workloads that utilize BF16 data formats.

TABLE 1

| Instruction Name | Pseudocode |
|---|---|
| V_PK_FMA_BF16 | Result [31:16] = fma_bf16(Src0[31:16], |
| | Src1[31:16], Src2[31:16]); |
| | Result [15:0] = fma_bf16(Src0[15:0], Src1[15:0], |
| | Src2[15:0]); |
| V_PK_ADD_BF16 | Result [31:16] = add_bf16(Src0[31:16], |
| | Src1[31:16]); |
| | Result[15:0] = add_bf16(Src0[15:0], Src1[15:0]); |
| V_PK_MUL_BF16 | Result[31:16] = mul_bf16(Src0[31:16], |
| | Src1[31:16]); |
| | Result[15:0] = mul_bf16(Src0[15:0], Src1[15:0]); |
| V_PK_MAX_NUM_BF16 | Result[31:16] = max_bf16(Src0[31:16], |
| | Src1[31:16]); |
| | Result[15:0] = max_bf16(Src0[15:0], Src1[15:0]); |
| V_PK_MIN_NUM_BF16 | Result[31:16] = min_bf16(Src0[31:16], |
| | Src1[31:16]); |
| | Result[15:0] = min_bf16(Src0[15:0], Src1[15:0]); |
| V_FMA_MIXHI_BF16 | If Src0 is BF16 |
| | Src0_F32 = CVT_F32_BF16(Src0) |
| | If Src1 is BF16 |
| | Src1_F32 = CVT_F32_BF16(Src1) |
| | If Src2 is BF16 |
| | Src2_F32 = CVT_F32_BF16(Src2) |
| | Tmp[31:0] = FMA_F32(Src0_F32, Src1_F32, |
| | Src2_f32) |
| | Result[31:16] = CVT_BF16_F32(Tmp) |
| V_FMA_MIXLO_BF16 | If Src0 is BF16 |
| | Src0_F32 = CVT_F32_BF16(Src0) |
| | If Src1 is BF16 |
| | Src1_F32 = CVT_F32_BF16(Src1) |
| | If Src2 is BF16 |
| | Src2_F32 = CVT_F32_BF16(Src2) |
| | Tmp[31:0] = FMA_F32(Src0_F32, Src1_F32, |
| | Src2_f32) |
| | Result[15:0] = CVT_BF16_F32(Tmp) |
| V_FMA_MIX_F32_BF16 | If Src0 is BF16 |
| | Src0_F32 = CVT_F32_BF16(Src0) |
| | If Src1 is BF16 |
| | Src1_F32 = CVT_F32_BF16(Src1) |
| | If Src2 is BF16 |
| | Src2_F32 = CVT_F32_BF16(Src2) |
| | Result[31:0] = FMA_F32(Src0_F32, Src1_F32, |
| | Src2_f32) |

The V_PK_FMA_BF16 instruction performs a packed fused multiply-add operation on BF16 data elements. As used herein, a packed operation is an operation that processes multiple data elements in parallel, such as within a vector processing pipeline of the processing unit. In the example of the V_PK_FMA_BF16 instruction, each 32-bit packed operand comprises two BF16 values, with the instruction computing the result for the high and low 16-bit portions independently. As part of the operation, the exponents of the high and low portions of the operands are implicitly aligned—the smaller exponent is adjusted to match the larger one, ensuring proper scaling of the mantissas during computation. In certain embodiments, the operation adheres to the “Round to Nearest Even” (RNE) rounding mode and uses a flag to determine whether to clamp overflow values to ±MAX. This enables efficient execution of multiply-add computations for packed BF16 data, reducing computational overhead.

The V_PK_ADD_BF16 instruction computes the element-wise addition of packed BF16 data. Each 32-bit operand contains two BF16 values, with the operation applied independently to the high and low 16-bit portions. In certain embodiments, the addition uses RNE rounding and includes a flag to handle overflow clamping. The instruction is optimized for vectorized addition in BF16-based workloads.

The V_PK_MUL_BF16 instruction performs element-wise multiplication on packed BF16 data. Similar to other packed instructions, it processes two BF16 values in each 32-bit operand independently. RNE rounding is applied to the results, with optional overflow clamping to ±MAX. This instruction supports efficient multiplication operations in matrix and tensor computations.

The V_PK_MAX_NUM_BF16 instruction calculates the element-wise maximum of two packed BF16 data operands. Each operand contains two BF16 values, with the maximum determined independently for the high and low 16-bit portions.

The V_PK_MIN_NUM_BF16 instruction calculates the element-wise minimum of two packed BF16 data operands. Similar to the corresponding maximum instruction V_PK_MAX_NUM_BF16, it operates independently on the high and low 16-bit portions of the packed operands. Such instruction enables efficient execution of operations requiring minimum value selection, such as clipping or data normalization.

The V_FMA_MIXHI_BF16 instruction performs a fused multiply-add operation on mixed-precision data, converting BF16 operands to FP32 for computation. It processes the high 16-bit portions of the packed BF16 data, converting them to FP32, performing the operation, and converting the result back to BF16. In certain embodiments, operand selection and location are controlled via specific flags, providing flexibility for mixed-precision workloads.

Similar to V_FMA_MIXHI_BF16, the V_FMA_MIXLO_BF16 instruction processes the low 16-bit portions of the packed BF16 data. It converts the BF16 values to FP32 for computation, performs a fused multiply-add operation, and converts the result back to BF16.

The V_FMA_MIX_F32_BF16 instruction extends mixed-precision fused multiply-add operations to 32-bit data, treating BF16 operands as FP32 for the computation. The results are calculated in FP32 and converted back to BF16 for storage.

Table 2 below presents a set of instructions for converting data between the BF16 and FP32 formats, substantially optimizing performance in mixed-precision computing environments in accordance with some embodiments. The example instruction set includes both packed operations (which convert multiple data elements simultaneously to maximize throughput) and scalar operations (which handle single data elements). These instructions enable transitions between the reduced-precision BF16 data format, commonly used for efficient storage and processing in machine learning workloads, and the higher-precision FP32 format, which provides greater numerical accuracy.

TABLE 2

| Instruction Name | Pseudocode |
|---|---|
| V_CVT_PK_BF16_F32 | V_CVT_PK_BF16_F32 Result, Src0, Src1 |
| | If (Src1 is NaN) { |
| | Result[31:16] = Src1[31:16] \| 0x40; |
| | } |
| | Else { |
| | Result[31:16] = src1[31:0] with RNE to BF16 |
| | } |
| | If (Src0 is NaN) { |
| | Result[15:0] = Src0[31:16] \| 0x40; |
| | } |
| | Else { |
| | Result[15:0] = src0[31:0] with RNE to BF16 |
| | } |
| V_CVT_SR_PK_BF16_F32 | V_CVT_SR_PK_BF16_F32 Result, Src0, Src1, Src2 |
| | If (Src1 is NaN) { |
| | Result[31:16] = Src1[31:16] \| 0x40; |
| | } |
| | Else { |
| | Tmp[31:0] = Src1[31:0] + Src2[31:16] |
| | Result[31:16] = Tmp[31:16] |
| | } |
| | If (Src0 is NaN) { |
| | Result[15:0] = Src0[31:16] \| 0x40; |
| | } |
| | Else { |
| | Tmp[31:0] = Src0[31:0] + Src2[15:0]; |
| | Result[15:0] = Tmp[15:0] |
| | } |
| V_CVT_F32_BF16 | V_CVT_F32_BF16 Result, Src0 |
| | Result[31:0] = {Src0, 16′d0} |

The V_CVT_PK_BF16_F32 instruction performs a packed conversion of two FP32 data elements to the BF16 data format. As used herein, a packed conversion refers to a process in which multiple data elements are converted simultaneously within a single instruction, with each data element independently transformed between specified formats. For example, in the context of BF16 and FP32 formats, a packed conversion typically operates on two 32-bit FP32 values stored within a single vector register, converting each value to a corresponding 16-bit BF16 representation. In certain embodiments, this approach leverages vectorized capabilities of the processing unit, enabling high-throughput data conversions while maintaining independent rounding and formatting for each data element. Each 32-bit FP32 value is independently converted to its corresponding 16-bit BF16 representation, with rounding applied using (as a non-limiting example) RNE. If any input value is a NaN (Not a Number), the result is adjusted to produce a quiet NaN (a NaN designed to propagate through most arithmetic operations without raising exceptions) in the BF16 data format. In the example instruction set, the V_CVT_PK_BF16_F32 instruction enables processing two FP32 values per cycle.

The V_CVT_SR_PK_BF16_F32 instruction extends the functionality of the packed conversion by adding support for stochastic rounding. It converts two FP32 data elements to the BF16 data format, combining the input data with additional rounding control parameters. The instruction also handles NaN inputs, ensuring quiet NaN outputs in BF16 data format. This instruction balances numerical precision and efficiency, with stochastic rounding reducing bias in iterative computations.

The V_CVT_F32_BF16 instruction converts a single FP32 data element into the BF16 data format. The conversion involves scaling the mantissa of the FP32 value based on its exponent to fit within the reduced 7-bit precision of BF16, while applying a rounding mode, such as RNE. If the input FP32 value is NaN (Not a Number), the output is adjusted to a quiet NaN in the BF16 data format. This instruction supports scalar processing workflows where high-throughput packed operations are not required, enabling precision-preserving conversions in contexts such as debugging, scalar arithmetic, or standalone data processing.

Table 3 below presents a set of specialized instructions for converting and scaling data between reduced-precision formats, such as 8-bit floating-point (FP8), 6-bit floating-point (FP6), 4-bit floating-point (FP4), 6-bit brain floating-point (BF6), 8-bit brain floating-point (BF8), and the BF16 data format. These instructions substantially optimize mixed-precision processing by enabling efficient transitions between formats of varying precision, with support for scaling and rounding operations during conversion both to and from BF16. Each instruction performs packed operations, processing multiple data elements simultaneously to maximize computational throughput. Additionally, stochastic rounding is supported in specific instructions, allowing for reduced bias in iterative computations, particularly in machine learning and AI workloads. The inclusion of scaling and precision-aware conversions ensures minimal data loss while preserving numerical fidelity across diverse operations.

TABLE 3

| Instruction Name | Pseudocode |
|---|---|
| V_CVT_SCALE_SR_PK32_FP6_BF16 | V_CVT_SCALE_SR_PK32_FP6_BF16 VDST[191:0], Src0[511:0], Src1[31:0], |
| | Src2[31:0] |
| | Src0 has 32 rows 32 columns of matrix data. Each two rows are one |
| | VGPR. 32 rows have 16 continuous VGPRs. |
| | Src1 is the random number for stochastic rounding. |
| | Src2 is a f32 value and its exp is the scale value for each column data |
| | which Src0 holds. |
| V_CVT_SCALE_PK32_FP6_BF16 | V_CVT_SCALE_PK32_FP6_BF16 VDST[191:0], Src0[511:0], Src1[31:0] |
| | Src0 has 32 rows 32 columns of matrix data. Each two rows are one |
| | VGPR. 32 rows have 16 continuous VGPRs. |
| | Src1 is a f32 value and its exp is the scale value for each column data |
| | which Src0 holds. |
| V_CVT_SCALE_SR_PK32_BF6_BF16 | V_CVT_SCALE_SR_PK_BF6_BF16 VDST[191:0], Src0[511:0], Src1[31:0], |
| | Src2[31:0] |
| | Src0 has 32 rows 32 columns of matrix data. Each two rows are one |
| | VGPR. 32 rows have 16 continuous VGPRs. |
| | Src1 is the random number for stochastic rounding. |
| | Src2 is a f32 value and its exp is the scale value for each column data |
| | which Src0 holds. |
| V_CVT_SCALE_PK32_BF6_BF16 | V_CVT_SCALE_PK32_BF6_BF16 VDST[191:0], Src0[511:0], Src1[31:0] |
| | Src0 has 32 rows 32 columns of matrix data. Each two rows are one |
| | VGPR. 32 rows have 16 continuous VGPRs. |
| | Src1 is a f32 value and its exp is the scale value for each column data |
| | which Src0 holds. |
| | The steps are substantially the same as V_CVT_SCALE_SR_PK_BF6_BF16 |
| | except the conversion from BF16 to BF6 use the round to nearest even |
| | instead of stochastic round. |
| V_CVT_SCALE_SR_PK8_FP4_BF16 | V_CVT_SCALE_SR_PK8_FP4_BF16 VDST[31:0], Src0[127:0], Src1[31:0], |
| | Src2[31:0] |
| | Src0 has 8 rows 32 columns of matrix data. Each two rows are one VGPR. |
| | 8 rows have 4 continuous VGPRs. |
| | Src1 is the random number for stochastic rounding. |
| | Src2 is a f32 value and its exp is the scale value for each column data |
| | which Src0 holds. |
| V_CVT_SCALE_PK8_FP4_BF16 | V_CVT_SCALE_PK8_FP4_BF16 VDST[31:0], Src0[127:0], Src1[31:0] |
| | Src0 has 8 rows 32 columns of matrix data. Each two rows are one VGPR. |
| | 8 rows have 4 continuous VGPRs. |
| | Src1 is a f32 value and its exp is the scale value for each column data |
| | which Src0 holds. |
| | The steps are substantially the same as |
| | V_CVT_SCALE_SR_PK8_FP4_BF16 except the conversion from BF16 to |
| | FP4 use the round to nearest even instead of stochastic round. |
| V_CVT_SCALE_SR_PK8_FP8_BF16 | V_CVT_SCALE_SR_PK_FP8_BF16 VDST[63:0], Src0[127:0], Src1[31:0], |
| | Src2[31:0] |
| | Src0 has 8 rows 32 columns of matrix data. Each two rows are one VGPR. |
| | 8 rows have 4 continuous VGPRs. |
| | Src1 is the random number for stochastic rounding. |
| | Src2 is a f32 value and its exp is the scale value for each column data |
| | which Src0 holds. |
| V_CVT_SCALE_PK8_FP8_BF16 | V_CVT_SCALE_PK_FP8_BF16 VDST[63:0], Src0[127:0], Src1[31:0] |
| | Src0 has 8 rows 32 columns of matrix data. Each two rows are one VGPR. |
| | 8 rows have 4 continuous VGPRs. |
| | Src1 is a f32 value and its exp is the scale value for each column data |
| | which Src0 holds. |
| | The steps are substantially the same as |
| | V_CVT_SCALE_SR_PK8_FP8_BF16 except the conversion from BF16 to |
| | FP8 use the round to nearest even instead of stochastic round. |
| V_CVT_SCALE_SR_PK8_BF8_BF16 | V_CVT_SCALE_SR_PK8_BF8_BF16 VDST[63:0], Src0[127:0], Src1[31:0], |
| | Src2[31:0] |
| | Src0 has 8 rows 32 columns of matrix data. Each two rows are one VGPR. |
| | 8 rows have 4 continuous VGPRs. |
| | Src1 is the random number for stochastic rounding. |
| | Src2 is a f32 value and its exp is the scale value for each column data |
| | which Src0 holds. |
| V_CVT_SCALE_PK8_BF8_BF16 | V_CVT_SCALE_PK8_BF8_BF16 VDST[63:0], Src0[127:0], Src1[31:0] |
| | Src0 has 8 rows 32 columns of matrix data. Each two rows are one VGPR. |
| | 8 rows have 4 continuous VGPRs. |
| | Src1 is a f32 value and its exp is the scale value for each column data |
| | which Src0 holds. |
| | The steps are substantially the same as |
| | V_CVT_SCALE_SR_PK8_BF8_BF16 except the conversion from BF16 to |
| | BF8 use the round to nearest even instead of stochastic round. |
| V_CVT_SCALE_PK8_BF16_FP4 | V_CVT_SCALE_PK8_BF16_FP4 Result[127:0], Src0[31:0], Src1[31:0] |
| | Src0 is the FP4 matrix. Thread0-15 is a 16 × 8 matrix and thread16-31 is |
| | another 16 × 8 matrix. |
| | Src1[31:0] is the scale VGPR, OP_SEL[0:1] is used to select the scale. |
| | Thread0-15 use 16 scale values and thread16-31 use another 16 scale |
| | values. |
| V_CVT_SCALE_PK32_BF16_FP6 | V_CVT_SCALE_PK_BF16_FP6 Result[511:0], Src0[191:0], Src1[31:0] |
| | Src0 is the FP6 matrix. Thread0-15 is a 16 × 32 matrix and thread16-31 is |
| | another 16 × 32 matrix. |
| | Src1[31:0] is the scale VGPR, OP_SEL[0:1] is used to select the scale. |
| | Thread0-15 use 16 scale values and thread16-31 use another 16 scale |
| | values. |
| V_CVT_SCALE_PK32_BF16_BF6 | V_CVT_SCALE_PK_BF16_BF6 Result[511:0], Src0[191:0], Src1[31:0] |
| | Src0 is the BF6 matrix. Thread0-15 is a 16 × 32 matrix and thread16-31 is |
| | another 16 × 32 matrix. |
| | Src1[31:0] is the scale VGPR, OP_SEL[0:1] is used to select the scale. |
| | Thread0-15 use 16 scale values and thread16-31 use another 16 scale |
| | values. |
| V_CVT_SCALE_PK8_BF16_FP8 | V_CVT_SCALE_PK_BF16_FP8 Result[127:0], Src0[63:0], Src1[31:0] |
| | Src0 is the FP8 matrix. Thread0-15 is a 16 × 8 matrix and thread16-31 is |
| | another 16 × 8 matrix. |
| | Src1[31:0] is the scale VGPR, OP_SEL[0:2] is used to select the scale. |
| | Thread0-15 use 16 scale values and thread16-31 use the same 16 scale |
| | values. |
| V_CVT_SCALE_PK8_BF16_BF8 | V_CVT_SCALE_PK_BF16_BF8 Result[127:0], Src0[63:0], Src1[31:0] |
| | Src0 is the BF8 matrix. Thread0-15 is a 16 × 8 matrix and thread16-31 is |
| | another 16 × 8 matrix. |
| | Src1[31:0] is the scale VGPR, OP_SEL[0:2] is used to select the scale. |
| | Thread0-15 use 16 scale values and thread16-31 use the same 16 scale |
| | values. |

The V_CVT_SCALE_SR_PK32_FP6_BF16 instruction converts and scales data elements from the FP6 format to BF16 while applying stochastic rounding. The operation involves identifying the exponent of the FP6 data element, scaling its mantissa to fit within the 7-bit precision of BF16, and rounding the result stochastically to reduce numerical bias. In this example, the instruction processes two FP6 data elements in parallel, enabling high throughput during mixed-precision conversions.

The V_CVT_SCALE_PK32_FP6_BF16 instruction performs a packed conversion of FP6 data elements to BF16 without stochastic rounding. It scales the mantissa of the FP6 data based on its exponent, applies deterministic rounding (e.g., Round to Nearest Even), and generates the corresponding BF16 representation. The packed operation processes two FP6 values simultaneously, making it suitable for high-performance workloads.

The V_CVT_SCALE_SR_PK32_BF6_BF16 instruction converts and scales data elements from BF6 to BF16 with stochastic rounding. By scaling the mantissa of BF6 data based on its exponent, the instruction ensures compatibility with BF16's dynamic range. Stochastic rounding is applied to mitigate rounding bias, and the packed operation processes two BF6 values in parallel for efficiency.

The V_CVT_SCALE_PK32_BF6_BF16 instruction converts BF6 data elements to BF16 using deterministic rounding. It scales the mantissa of the BF6 data, rounds it deterministically (e.g., RNE mode), and generates the BF16 representation. The packed functionality provided by the instruction allows for the simultaneous processing of two BF6 data elements.

The V_CVT_SCALE_SR_PK8_FP4_BF16 instruction converts and scales data elements from FP4 to BF16, incorporating stochastic rounding to handle the reduced precision of FP4. The mantissa of each FP4 value is scaled to match the precision of BF16, with stochastic rounding applied to minimize bias. This packed instruction processes four FP4 values per operation, maximizing throughput.

The V_CVT_SCALE_PK8_FP4_BF16 instruction performs a packed conversion of FP4 data elements to BF16 using deterministic rounding. It scales the mantissa of FP4 values to align with the BF16 data format and applies a predefined rounding mode, such as RNE. The packed operation processes four FP4 data elements in parallel.

The V_CVT_SCALE_SR_PK8_FP8_BF16 instruction converts FP8 data elements to BF16 with stochastic rounding. The conversion scales the FP8 mantissa based on its exponent and adjusts the value to fit within BF16 precision using stochastic rounding. The packed operation handles four FP8 values per instruction cycle.

The V_CVT_SCALE_PK8_FP8_BF16 instruction performs a packed conversion of FP8 data elements to BF16 without stochastic rounding. It scales the mantissa based on the FP8 exponent and rounds deterministically, producing BF16 results. The instruction processes four FP8 data elements per cycle.

The V_CVT_SCALE_SR_PK8_BF8_BF16 instruction converts BF8 data elements to BF16 using stochastic rounding. The conversion scales the BF8 mantissa, applies stochastic rounding to maintain numerical fidelity, and generates BF16 results. The packed operation processes four BF8 data elements in a single cycle.

The V_CVT_SCALE_PK8_BF8_BF16 instruction converts BF8 data elements to BF16 using deterministic rounding. The mantissa is scaled based on the BF8 exponent, rounded deterministically (e.g., RNE mode), and stored in the BF16 data format. This packed operation processes four BF8 data elements in parallel.

The V_CVT_SCALE_PK8_BF16_FP4 instruction converts and scales BF16 data elements to the FP4 format. The conversion process involves scaling the mantissa of each BF16 value to fit the reduced precision of FP4, while applying a predefined rounding mode, such as Round to Nearest Even (RNE). The packed operation processes four BF16 data elements in parallel, generating FP4 outputs that are suitable for low-precision tasks, such as intermediate computations in neural network inference. In certain embodiments, this instruction is optimized for resource-constrained environments, in which reduced-precision formats like FP4 provide significant performance and memory advantages.

The V_CVT_SCALE_PK32_BF16_FP6 instruction converts BF16 data elements to the FP6 format, scaling the mantissa of each BF16 value to fit the reduced precision of FP6. The conversion applies a predefined rounding mode, such as RNE, to manage precision loss. This packed operation processes two BF16 data elements per cycle, generating FP6 outputs suitable for (as non-limiting examples) memory-constrained environments and low-precision computations.

The V_CVT_SCALE_PK32_BF16_BF6 instruction converts BF16 data elements to the BF6 format. The mantissa of each BF16 value is scaled and rounded to align with the reduced precision and dynamic range of BF6. The conversion uses deterministic rounding, such as RNE, to ensure consistent results. The packed functionality processes two BF16 values simultaneously.

The V_CVT_SCALE_PK8_BF16_FP8 instruction converts BF16 data elements to the FP8 format, scaling the mantissa of each BF16 value to align with FP8's reduced precision. In the example, the conversion applies a predefined rounding mode such as RNE to manage precision loss during scaling. The packed operation processes four BF16 data elements per cycle, producing FP8 outputs optimized for low-precision tasks in memory-constrained environments.

The V_CVT_SCALE_PK8_BF16_BF8 instruction converts BF16 data elements to the BF8 format. It scales the mantissa of each BF16 value to match BF8's precision and dynamic range, applying deterministic rounding (e.g., RNE) to generate consistent results. The packed operation handles four BF16 data elements simultaneously.

Table 4 below describes specialized instructions for transcendental operations involving BF16-formatted data. These instructions implement mathematical functions such as reciprocal, exponentiation, logarithms, square roots, and trigonometric and hyperbolic calculations. In certain embodiments, these transcendental instructions leverage dedicated hardware resources, such as transcendental arithmetic logic units (transcendental ALUs), to optimize performance for workloads in machine learning, graphics, and other computationally intensive applications. Each instruction processes BF16 inputs and generates BF16 outputs.

TABLE 4

| Instruction Name | Description |
|---|---|
| V_RCP_BF16 | Computes the reciprocal of a BF16 data element (Result = 1/Src). Both |
| | input and output are in BF16 format. |
| V_EXP_BF16 | Calculates the exponential function (e^{x}) for a BF16 input. The instruction |
| | uses polynomial approximations with BF16 precision. |
| V_LOG_BF16 | Evaluates the natural logarithm (ln(x)) of a BF16 data element. This |
| | instruction is typically used for workloads requiring logarithmic |
| | transformations, such as neural network activations. |
| V_SQRT_BF16 | Determines the square root (sqrt{x}) of a BF16 data element. |
| V_SIN_BF16 | Computes the sine (sin(x)) of a BF16 input. In certain embodiments, the |
| | instruction provides this trigonometric functionality using one or more |
| | dedicated transcendental ALUs. |
| V_COS_BF16 | Computes the cosine (cos(x)) of a BF16 input. In certain embodiments, |
| | the instruction provides this trigonometric functionality using one or |
| | more dedicated transcendental ALUs. |
| V_RSQ_BF16 | Computes the reciprocal square root (1/sqrt{x}) operation for BF16 data |
| | elements. This instruction supports various applications, such as in |
| | machine learning and graphics pipelines. |
| V_TANH_BF16 | Computes the hyperbolic tangent (tanh(x)) of a BF16 input. In certain |
| | embodiments, this instruction is utilized in machine learning applications |
| | for neural network activation functions. |

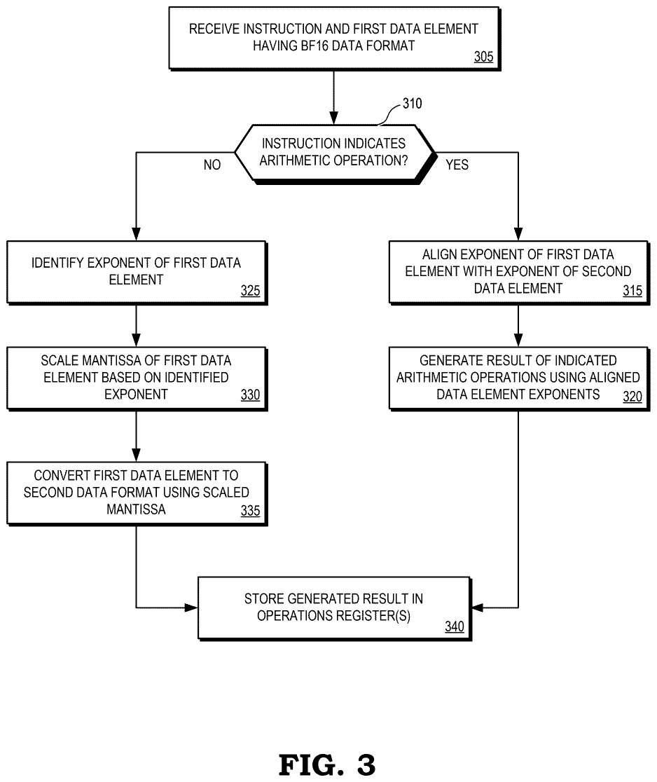

FIG. 3 is a flow diagram illustrating an operational routine 300 for processing instructions involving BF16-formatted data elements in a processing system, in accordance with some embodiments. The routine 300 begins at block 305, in which an instruction and a first data element having a BF16 data format are received by a processing unit (e.g., parallel processor 215 from FIG. 2). The instruction may specify either an arithmetic operation or a conversion operation to be performed on the received data element.

At decision block 310, the processing unit (such as via command processor 226 of FIG. 2) determines whether the instruction indicates an arithmetic operation. If the instruction specifies an arithmetic operation, the routine 300 proceeds to block 315. At block 315, the processing unit (such as via compute unit 224 of FIG. 2) aligns an exponent of the first data element with the exponent of a second data element. This alignment involves adjusting the mantissa of one or both data elements to ensure they are represented on a common scale, enabling accurate arithmetic computation.

Once the exponents are aligned, the routine 300 continues to block 320, in which the processing unit generates the result of the indicated arithmetic operation using the aligned exponents. The arithmetic operation may include operations such as FMA, addition, or multiplication. The aligned exponents ensure numerical precision during these operations.

If, at decision block 310, the instruction indicates a conversion operation instead of an arithmetic operation, the routine 300 proceeds to block 325. At block 325, processing unit identifies the exponent of the first data element. Using this identified exponent, the processing unit scales the mantissa of the first data element at block 330 to fit the precision and dynamic range of the target data format. The scaling ensures accurate representation of the data element in the target format.

At block 335, the processing unit converts the first data element to the second data format using the scaled mantissa. This conversion involves rounding, such as Round to Nearest Even or stochastic rounding, to maintain numerical fidelity while adapting the data to the reduced precision or alternate structure of the target format.

After completing either the arithmetic or conversion operation, the routine 300 proceeds to block 340, in which the processing unit stores the generated result in one or more operations registers of the processing unit. These registers enable access to the results for subsequent processing or external memory storage.

In some embodiments, the apparatus and techniques described above are implemented in a system including one or more integrated circuit (IC) devices (also referred to as integrated circuit packages or microchips), such as the processing system and operations involving BF16-formatted data described above, including with reference to FIGS. 1 and 2. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to physical structure (e.g., electronic circuitry). More specifically, this formulation is used to indicate that this physical structure is arranged to perform the one or more tasks during operation. Such physical structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a processing unit, an instruction and a first data element having a 16-bit brain floating-point (BF16) data format, the instruction indicating an arithmetic operation or a conversion operation;
processing the instruction via processing circuitry of the processing unit based on an exponent of the first data element to generate a result; and
storing the generated result at one or more operations registers of the processing unit for use in execution of one or more workloads associated with the instruction.

2. The method of claim 1, wherein the instruction indicates an arithmetic operation that is one of a group that includes a fused multiply-add operation, an addition operation, or a multiplication operation, and wherein the method comprises, responsive to the instruction indicating the arithmetic operation:
aligning, via processing circuitry of the processing unit, a first exponent of the first data element with a second exponent of a second data element; and
generating, via the processing circuitry, the result of the indicated arithmetic operation using the aligned first and second exponents.

3. The method of claim 2, wherein the aligning comprises shifting a mantissa of the first data element or a mantissa of the second data element based on a difference between the first exponent and the second exponent.

4. The method of claim 1, wherein the instruction indicates an arithmetic operation, and wherein the method further comprises modifying the generated result to have a second data format that is different than the BF16 data format.

5. The method of claim 1, further comprising storing the first data element in one or more of the one or more operations registers of the processing unit prior to the processing of the instruction.

6. The method of claim 1, further comprising performing normalization on the generated result in accordance with the BF16 data format.

7. The method of claim 1, wherein the instruction indicates a conversion operation, and wherein the method comprises, responsive to the instruction indicating the conversion operation:
identifying, via the processing circuitry of the processing unit, a first exponent of the first data element; and
generating the result via the processing circuitry of the processing unit by converting the first data element to a second data format that is different than the BF16 data format, the converting comprising scaling a mantissa of the first data element based on the identifying of the first exponent, and the second data format being one of a group that includes floating-point 32-bit (FP32), floating-point 6-bit (FP6), floating-point 4-bit (FP4), brain floating-point 6-bit (BF6), brain floating-point 8-bit (BF8), and floating-point 8-bit (FP8).

8. The method of claim 7, wherein converting the first data element to the second data format comprises applying a rounding mode that is one of a group that includes round to nearest even, round down, or stochastic rounding.

9. The method of claim 1, wherein the instruction indicates a packed operation that processes multiple data elements in parallel.

10. A processing system comprising:
command processor circuitry to receive an instruction and a first data element having a 16-bit brain floating-point (BF16) data format, and to determine whether the instruction indicates an arithmetic operation or a conversion operation;
a compute unit communicatively coupled to the command processor circuitry and configured to process the instruction based on an exponent of the first data element to generate a result; and
one or more operations registers to store the generated result.

11. The processing system of claim 10, wherein the instruction indicates an arithmetic operation that is one of a group that includes a fused multiply-add operation, an addition operation, or a multiplication operation, and wherein to process the instruction comprises, responsive to the instruction indicating the arithmetic operation:
aligning a first exponent of the first data element with a second exponent of a second data element; and
generating the result of the indicated arithmetic operation using the aligned first and second exponents.

12. The processing system of claim 11, wherein the compute unit is further configured to modify the generated result to have a second data format that is different than the BF16 data format.

13. The processing system of claim 11, wherein the aligning comprises shifting a mantissa of the first data element or a mantissa of the second data element based on a difference between the first exponent and the second exponent.

14. The processing system of claim 10, wherein the one or more operations registers are configured to store the first data element prior to the processing of the instruction.

15. The processing system of claim 10, wherein the compute unit is further configured to normalize the generated result in accordance with the BF16 data format.

16. The processing system of claim 10, wherein the instruction indicates a conversion operation, and wherein to process the instruction comprises, responsive to the instruction indicating the conversion operation:
identifying a first exponent of the first data element; and
generating a result by converting the first data element to a second data format that is different than the BF16 data format, wherein the converting comprises scaling a mantissa of the first data element based on the identifying of the first exponent and wherein the second data format is one of a group that includes floating-point 32-bit (FP32), floating-point 6-bit (FP6), floating-point 4-bit (FP4), brain floating-point 6-bit (BF6), brain floating-point 8-bit (BF8), and floating-point 8-bit (FP8).

17. The processing system of claim 16, wherein converting the first data element to the second data format comprises applying a rounding mode that is one of a group that includes round to nearest even, round down, or stochastic rounding.

18. The processing system of claim 10, wherein the instruction specifies a packed operation, such that the compute unit processes multiple data elements in parallel.

19. A command processor of a parallel processor, the command processor configured to:
receive an instruction and a first data element having a 16-bit brain floating-point (BF16) data format, the instruction indicating a BF16 arithmetic operation or a BF16 conversion operation;
responsive to the instruction indicating an arithmetic operation, forwarding the instruction and the first data element to a compute unit to align a first exponent of the first data element with a second exponent of a second data element, and to generate a result of the indicated arithmetic operation using the aligned first and second exponents; and
responsive to the instruction indicating a conversion operation, forwarding the instruction and the first data element to a compute unit to identify a first exponent of the first data element, and to generate a result by converting the first data element to a second data format that is different than the BF16 data format, the converting comprising scaling a mantissa of the first data element based on the identifying of the first exponent.

20. The command processor of claim 19, wherein the instruction indicates an arithmetic operation that is one of a group that includes a fused multiply-add operation, an addition operation, or a multiplication operation.
